(19) United States
(12) Patent Application Publication
(10) Pub. No.: US 2018/0371200 A1
(43) Pub. Date: Dec. 27, 2018

(54) PROCESS FOR REDUCING FORMALDEHYDE CONTENT FROM CATIONIC MELAMINE-FORMALDEHYDE RESIN SOLUTION

(71) Applicant: RHODIA POLIAMIDA E ESPECIALIDADES S.A., Sao Paulo - SP (BR)

(72) Inventors: Eder TORRES, Sao Paulo (BR); Aires IACOVONE, Sao Paulo (BR)

(21) Appl. No.: 16/061,825

(22) PCT Filed: Dec. 16, 2015
(86) PCT No.: PCT/IB2015/002364

§ 371 Date: Jun. 13, 2018

(51) Int. Cl. C08J 9/28; B01D 61/14; C08G 12/32; C08G 85/00; C08L 61/28

(52) U.S. Cl. CPC C08J 9/286; B01D 61/145; C08G 12/32; C08G 85/002; B01D 71/68; C08J 2361/28; B01D 2311/06; B01D 2311/2634; C08L 61/28

(57) ABSTRACT

The present invention generally relates to a process for reducing formaldehyde content from cationic melamine-formaldehyde resin solution. Said process comprises the steps consisting of charging a starting solution to an ultrafiltration membrane system, separating said starting solution into a concentrate solution which mainly comprises cationic melamine-formaldehyde resin of high molecular weight, formaldehyde and water, and a permeate solution which mainly comprises cationic melamine-formaldehyde resin molecules of low molecular weight, formaldehyde, acid compounds and water and treating the permeate solution to reduce the free formaldehyde content of the permeate.

### TECHNICAL FIELD

The present invention generally relates to a process for reducing formaldehyde content from cationic melamine-formaldehyde resin solution. More specifically, the present invention describes to obtain a cationic melamine-formaldehyde resin solution with reduced levels of free formaldehyde, but maintaining the same characteristics and properties of the starting solution, which can be used in a variety of applications with reduced environmental, health and safety risks.

### PREVIOUS ART

In crude oil production the generation of water-in-oil emulsions must be controlled, otherwise these emulsions may increase the viscosity and provoke corrosion issues which can seriously affect the production of oil. The produced water can generate several problems if its separation from water-in-oil emulsions is not efficient and effective, such as overloading of surface separation equipment, increased cost of pumping wet crude, and corrosion problems.

Water-in-oil crude oil emulsions may be encountered at all stages in the petroleum production and processing industry and chemical methods for breaking emulsion are common in both oilfield and refinery. Chemical agents typically act on the interfacial film by either reacting chemically with the polar crude oil components or by modifying the environment of the dispersed droplets (demulsification). Among chemical agents, interfacially-active demulsifiers which weaken the stabilizing films to enhance droplet coalescence are preferred due to lower addition rates needed.

A range of different compounds have been used as demulsifiers or emulsion breakers, including resin alkoxylates, polyol/acrylic copolymers, polyols, esters, diepoxyde and polyglycols. Within the same chemical family, various amounts of ethylene oxide and propylene oxide can be added and result in different final products.

In addition to the water separation from crude oil using emulsion breakers in order to ensure the oil quality, it is also important to ensure that the produced water (water separated from crude oil) presents low oil quantity. Untreated produced water may present more than 5% of residual oil, as oil-in-water emulsion. It has been disclosed in U.S. Pat. No. 4,481,116 that a cationic melamine-formaldehyde polymer resin based on melamine, formaldehyde and glyoxal may be applied as reverse emulsion breaker, also called deoiler or water clarifier, to ensure this low oil quantity in the produced water.

The melamine-formaldehyde polymer is obtained by the hydroxy methylation reaction of melamine with formaldehyde and glyoxal, followed by polymerization by condensation of methylol (hydroxymethyl) groups formed.

The melamine is a white and water insoluble solid, which has two active hydrogens per primary amine group and can react with up to six aldehyde groups and produce two intermediates, tri and hexamethylolmelamine. In an acid medium such intermediates decompose and releases formaldehyde.

In addition to its application as reverse demulsifier, aqueous solutions of melamine-formaldehyde polymers are known to have a wide variety of industrial uses. For example, the said polymer, sometimes referred to melamine-formaldehyde resin, is applied to various fabrics as textile finishes. The resin is known to improve the humidity resistance of paper products and to crosslink many industrially applied coatings. Melamine-formaldehyde resin is also commonly used as flocculating agents in the treatment of wastewater. However, in each of these uses the presence of free formaldehyde exhibits several disadvantages. The free formaldehyde may have a deleterious effect on the material being treated by the resin, can impart an undesirable odor and in a demulsifier formulation may cause corrosion, flammability and toxicity. Therefore, a cationic melamine-formaldehyde resin solution which does not include formaldehyde would represent an advance in many different applications requiring low formaldehyde levels for environmental, health and safety reasons.

Several technologies have been proposed to remove free formaldehyde. Distillation of aqueous formaldehyde solutions under various pressures shows that higher distillation pressures generate formaldehyde-enriched distillate, as described by Piret (Piret, E. L., Hal, M. W., Distillation Principles of formaldehyde Solutions—Liquid-Vapor Equilibrium and the Effect of Partial Condensation, Industrial and Engineering Chemistry, Vol. 40, no 4, April, 1948), but this approach prejudices the stability of the melamine-formaldehyde polymer. Alternatively, it is possible react the formaldehyde with methanol to form dimethoxymethane, which can be removed by distillation at reduced pressure. However, distillation under reduced pressure is not effective in removing formaldehyde from melamine-formaldehyde resin solution, since it causes a decrease in the viscosity of the final resin solution and an increase in solids content to 15% w/w.

The U.S. Pat. No. 4,935,149 describes formaldehyde scavenging agent consisting of urea, acetylacetone or a combination of urea with glyoxal or acetylacetone, which is added to an aqueous solution of melamine-formaldehyde polymer used as a detackifier in a paint overspray control system. The U.S. Pat. No. 6,100,368 discloses the addition of hydrogen peroxide and/or iron in the form of ferric ion to the acidification stage of the production of melamine-formaldehyde polymers to reduce levels of free formaldehyde. However, melamine-formaldehyde polymer solution has its viscosity reduced, due to breakage of the polymer chain during the oxidation process, and its color enhanced. Consequently, the processes for reducing the formaldehyde content involving the use of scavenging agents or oxidation should be used when the solution contains only low levels of formaldehyde, in which only a small quantity of scavenging agent or oxidizer is required to achieve the appropriate formaldehyde content. Otherwise, some properties of the cationic melamine-formaldehyde resin, such as viscosity, pH and color, may be altered.

One of the objects of the invention is to propose an improved process for reducing formaldehyde content from cationic melamine-formaldehyde resin solution, which results in a product having the same characteristics and properties of the starting solution, keeping the structure unaltered and consequently the properties of the polymer chain.

The process reduces levels of free formaldehyde to less than 0.1% by weight, in such a way that the polymer solution may be used in a variety of applications, such as flocculating agents, in the treatment of wastewater, as textile finishes, as adhesion-promoting agent for varnish or other coatings applied to protect solid supports, as moisture-resistant agent for paper and the like, and as reverse demulsifier in oilfield and refinery, without creating an environmental risk due to an unacceptable level of free formaldehyde.

### SUMMARY OF THE INVENTION

The invention thus provides a process for reducing formaldehyde content from cationic melamine-formaldehyde resin solution comprising the following steps:
a) Charging a starting solution of a cationic melamine-formaldehyde resin to a ultrafiltration membrane system;
b) Separating said starting solution into:
   i. a concentrate solution which mainly comprises cationic melamine-formaldehyde resin of high molecular weight, formaldehyde and water, and
   ii. a permeate solution which mainly comprises cationic melamine-formaldehyde resin molecules of low molecular weight, formaldehyde, acid compounds and water;
c) Treating the permeate solution to reduce the free formaldehyde content of the permeate;
d) Mixing the concentrate solution with the treated permeate or with water.

The present invention also proposes a cationic melamine-formaldehyde resin with a free formaldehyde content of less than 0.1% and a cationic melamine-formaldehyde resin obtainable by the hydroxy methylation reaction of melamine with formaldehyde and glyoxal followed by polymerization by condensation of methylol groups having a free formaldehyde content of less than 0.1%.

Also, the present invention proposes the use of a cationic melamine-formaldehyde resin as reverse emulsion breaker, flocculating agent, textile finish, adhesion-promoting agent and moisture-resistant agent.

### BRIEF DESCRIPTION OF THE DRAWINGS

FIG. 1 is a schematic diagram of the process according to one embodiment of the invention, without membrane washing.

FIG. 2 is a schematic diagram of the process according to another embodiment of the invention, with membrane washing.

FIG. 3 is a graph comparing the performance of the formulations according to the Application Test, as percentage of TOG (Total Oil and Grease) Reduction.

### DETAILED DESCRIPTION OF THE INVENTION

The invention provides a process for reducing formaldehyde content from cationic melamine-formaldehyde resin solution comprising the following steps:
a) Charging a starting solution of a cationic melamine-formaldehyde resin to a ultrafiltration membrane system;
b) Separating said starting solution into:
   i. a concentrate solution which mainly comprises cationic melamine-formaldehyde resin of high molecular weight, formaldehyde and water, and
   ii. a permeate solution which mainly comprises cationic melamine-formaldehyde resin molecules of low molecular weight, formaldehyde, acid compounds and water;
c) Treating the permeate solution to reduce the free formaldehyde content of the treated permeate;
d) Mixing the concentrate solution with the treated permeate or with water.

Cationic melamine-formaldehyde resin is typically obtained by the hydroxy methylation reaction of melamine with formaldehyde and glyoxal followed by polymerization by condensation of methylol (hydroxymethyl) groups formed. The hydroxy-methylation is the step in which the amine (melamine) is transformed into compounds capable of polymerized with each other or with other melamine molecules that are not hydroxy-methylated yet.

Typically, the formaldehyde used in the synthesis of cationic melamine-formaldehyde resin contains 10% to 15% w/w of methanol which acts as an inhibitor of polymerization and antioxidant, and about 0.02% of free formic acid. During the synthesis, the complete dissolution of melamine in the reaction mass indicates the reaction of hydroxyl-methylation and the polymerization is characterized by an increase in viscosity. The presence of glyoxal in the polymer backbone increases the water dispersibility of the polymer formed.

Usually, a 40% solution of aqueous formaldehyde is heated at 70° C. to 75° C. and the melamine powder is then added. Once the melamine powder is completely dissolved and the solution is clear, the mixture is added to a dilute solution of acid and glyoxal.

According to the present invention, the cationic melamine-formaldehyde resin solution employed as a starting solution for the present process is an aqueous solution which may present an amount of free formaldehyde of between 0.1% and 3.5%, preferably between 0.8% and 3.0%, more preferably between 1.5% and 2.5%, by weight based on the weight of the starting solution. The free formaldehyde content can be determined using the colorimetric method with acetylacetone or iodometric titration.

The pH of the starting solution can be in the range of 3.0 to 4.0. The viscosity of the starting solution can be between 10 cP·s and 100 cP·s, preferably between 20 cP·s and 60 cP·s. Solid content of the starting solution can be between 10% and 20%, preferably between 11% and 15% and most preferably between 12% and 13%, by weight based on the weight of the starting solution.

In step (a), the starting solution is charged to an ultrafiltration membrane system.

An ultrafiltration membrane system with a suitable “cut-off” for retention of the desired high molecular weight fractions may be used in the present invention. The membranes can be selected from the group consisting of membranes whose material are polysulphones, cellulose acetates, polyamides, vinyl chloride-acrylonitrile copolymers and poly(vinylidene fluoride), preferably polyethersulphone. The geometry of the membrane system is selected from the group consisting of tubular, hollow fiber, spiral-wound, plate and frame, preferably the ultrafiltration membrane system is a spiral-wound module.

The geometry selection of the membrane depends on various factors such as characteristics of solution to be fractionated, ease of operation, cleaning and maintenance. For example, the hollow fiber module has high membrane surface per volume unit, is easy to operate and maintain, and its power consumption is low. The spiral-wound module has flow rate almost constant and turbulence promoter mechanisms present along the membrane surface, reducing the fouling and facilitating cleaning thereof.

The separation of substances depends on the “cut-off” membrane value, which is indicated by the size of the smallest molecule retained by the membrane. Thus the molecules smaller than the “cut-off” membrane value pass through, whereas larger are retained. Usually, ultrafiltration process involves the use of membranes that separate molecules having a molecular weight in the range of 1 to 200 kDa.

For cationic melamine-formaldehyde resins the desired high molecular weight fraction may be in the range of 5 to 50 kDa, preferably about 10 kDa and the separation is thus carried out to give essentially 95% of this fraction as the membrane-retained component, called herein as concentrate. Thus the membrane used in this invention can have a pore size of between 5 kDa and 50 kDa, preferably about 10 kDa.

In step (b), the starting solution is separated into two solutions, a concentrate and a permeate.

The concentrate solution according to the present invention comprises the melamine-formaldehyde resin of high molecular weight. The expression “high molecular weight” in the sense of the present invention covers all polymers with a molecular weight higher than 50 kDa.

The permeate solution according to the present invention comprises melamine-formaldehyde molecules of low molecular weight. The expression “low molecular weight” in the sense of the present invention covers all molecules with a molecular weight lower than 50 kDa.

Advantageously, after the separation step, the melamine-formaldehyde resin of high molecular weight is mainly comprised in the concentrate solution, and the permeate solution is free or essentially free of melamine-formaldehyde resin of high molecular weight.

The concentrate solution can have a solid content of 10% to 19% by weight based on the weight of the concentrate solution. The permeate solution can comprises a formaldehyde content of 0.1% to 2.5% by weight based on the weight of permeate solution. The concentrate solution can also comprise formaldehyde, with a content of 0.1% to 2.5% by weight based on the weight of concentrate solution.

The process can be generally operated at pressure ranging from 0.3 bar to 9.7 bar, preferably from 0.5 bar to 2.0 bar and it may be applied with a pressure chamber with or without gas, as nitrogen.

A turbulent and/or laminar flow can be imposed on the cationic melamine-formaldehyde resin solution in contact with the membrane. Both flows agitate the solution in contact with the membrane and it allows to obtain a concentrate with resin of high molecular weight and a permeate with molecules of low molecular weight. However, the turbulent flow may be preferably applied because it provides a higher permeability reducing the film formation on the membrane surface and thereby reducing the membrane cleaning cycles, required for its restoration.

The flux through the membranes can be improved by increasing the temperature. For the separation of cationic melamine-formaldehyde resin solution in the membranes of the present invention, the temperatures may vary from 15° C. to 30° C., preferably from 20° C. to 25° C.

Then, according to step (c) the permeate solution obtained in step (b) can be treated with a means for reducing free formaldehyde content. Said means may be any formaldehyde-free reducing agent, such as oxidizing agent, scavenging agent or precipitation agent.

According to a preferred embodiment, the permeate solution can be treated with an oxidizing agent, preferably hydrogen peroxide. The oxidizing agent may be added to the permeate solution in an amount of between 20% and 100% excess, preferably between 30% and 50% excess by weight based on the weight of the permeate solution. Then the permeate solution can be heated at a temperature from 15° C. to 100° C. preferably from 65° C. to 80° C. After that, the treated permeate can be cooled to a temperature from 15° C. to 50° C., preferably at 20° C. to 30° C. Heating allows that the formaldehyde in the permeate solution is converted to formic acid via an oxidation with excess of the oxidizing agent added. This reaction is exothermic, and the oxidizing agent residual is decomposed thermally while all the formaldehyde is oxidized.

The treated permeate solution, free or substantially free from formaldehyde, can be discharged or otherwise reused within the present process. The process according to the invention comprises a step (d) consisting in mixing the concentrated solution with the treated permeate or with water.

According to a preferred embodiment, the step (d) consists in mixing the concentrate solution with treated permeate. This reuse in the present process is possible because the formic acid levels generated in the oxidation and present in the permeate solution do not affect the characteristics and properties of the cationic melamine-formaldehyde resin solution and furthermore, this reuse generates less effluent.

According to another embodiment, the step (d) consists in mixing the concentrated solution with water. Then, if the treated permeate solution is not reused, it can be discharged in a wastewater, since the formaldehyde is not present in the solution there is no environmental risk involved.

If the process according to the invention is carried out successively several times, then the ultrafiltration combined with the mixing of the concentrate solution with another flow may be seen as a diafiltration. The diafiltration increases the permeation of no high molecular weight species across the membrane, thereby enabling the concentration of the high molecular weight species in the concentrate solution. This technique involves washing out the concentrate solution by adding water or the treated permeate at the same rate, i.e. volume, as permeate is being generated. As a result, the concentrate solution volume does not change during the diafiltration process and the purity enhances.

Preferably, the volume of water or the treated permeate solution added in this step is the same volume of the permeate solution which was separated in step (b). There may be a slight adjustment of this volume to keep the cationic melamine-formaldehyde resin solution at the end of the process with the same specified solid content, however, the mass balance is maintained.

In one embodiment of the present invention, following the mixing step (d), the concentrate solution can be charged as part of the starting solution to another ultrafiltration membrane system, and the process can be repeated as many times as necessary to reach adequate levels of formaldehyde, preferably less than 0.1% by weight.

The ultrafiltration membrane permeability after several filtration cycles may be compromised. Therefore, optionally, after each cycle the membrane can be washed with water or with treated permeate to restore its permeability.

According to an advantageous embodiment, the ultrafiltration membrane system may be regenerated by washing it with water or with the treated permeate solution obtained in step (c) at a temperature below 50° C.

The present invention also proposes a cationic melamine-formaldehyde resin with a free formaldehyde content of less than 0.1% and a cationic melamine-formaldehyde resin obtainable by the hydroxy methylation reaction of melamine with formaldehyde and glyoxal followed by polymerization by condensation of methylol groups having a free formaldehyde content of less than 0.1%.

The present invention also proposes the use of a cationic melamine-formaldehyde resin described above as reverse emulsion breaker, flocculating agent, textile finish, adhesion-promoting agent and moisture-resistant agent.

The present invention provides advantages over existing process for reducing formaldehyde content from cationic melamine-formaldehyde resin solution. The invention proposes an improved process to reduce levels of free formaldehyde by aligning the ultrafiltration with a treatment for reducing formaldehyde content. This process is advantageously operated at low temperatures without changing the cationic melamine-formaldehyde resin solution characteristics such as viscosity, color and solid content, indicating that the polymer chain is not broken by the treatment for reducing formaldehyde content. Cationic melamine-formaldehyde resin solution produced using the process according to the invention maintains preferably the same characteristics and properties of the starting solution and it can be applied in different applications requiring low formaldehyde levels, considering its reduced environmental, health and safety risks.

Other details or advantages of the invention will become more clearly apparent in the light of the examples given below.

### EXAMPLES

### Example 1: Membrane Permeability

The evaluation of membrane permeability was verified after three successive batch processes made according to the present invention, with or without membrane washing.

For the examples below, the cationic melamine-formaldehyde resin solution with reduced levels of free formaldehyde was obtained through an ultrafiltration membrane system with the following characteristics: polyethersulphone membrane with a hollow fiber module, 0.8 to 0.9 mm fiber outside diameter, tapped density of 800 m²/m³ and permeation area of 0.072 m².

The starting solution of cationic melamine-formaldehyde resin, with a viscosity of 40.6 cP·s, pH 2.98, and solid content of 12.70% w/w, was separated into two solutions, the concentrate and the permeate.

At each cycle the permeate solution was oxidized with 50% excess of hydrogen peroxide, at a temperature above 65° C., for 2 h, until complete consumption of formaldehyde and hydrogen peroxide.

### Example 1.1: Evaluation without Membrane Washing

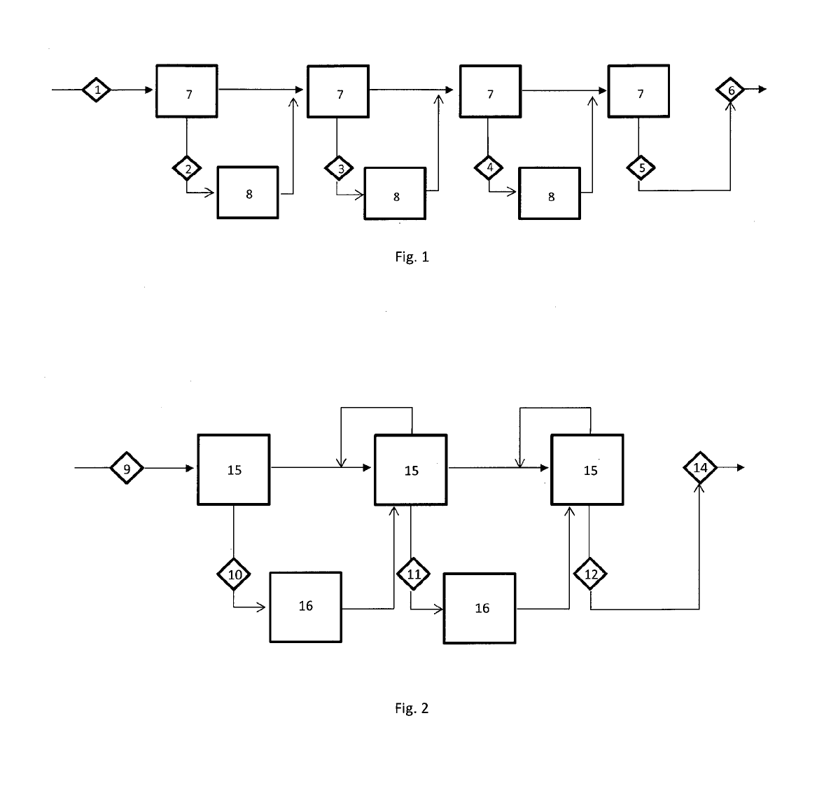

The treated permeate was added to the concentrate solution obtained in the same cycle to restore the original dispersion, as shown in FIG. 1. FIG. 1 is a schematic diagram of this process and its numbers represent the following descriptions:

1: Stating solution
2, 3, 4 and 5: Permeate solution
6: Concentrate solution

### 7: Membrane

8: Conditions of the permeate solution treatment (H₂O₂ 35%, 50% excess at 75° C. during 2 h)

TABLE 1
Parameters analyzed in each cycle

| | Stream | | | | | |
|---|---|---|---|---|---|---|
| | 1 | | | | | 6 |
| | Starting | | | | | Final |
| Parameters | Solution | 2 | 3 | 4 | 5 | Solution |
| Formaldehyde (%) | 2.11 | 1.684 | 1.18 | 0.83 | 0.53 | 0.55 |
| Hydrogen peroxide (%) | 0.00 | 0.00 | 0.09 | 0.09 | 0.01 | 0.00 |
| Viscosity (cP · s) | 40.60 | 2.70 | 1.50 | 1.65 | 0.75 | 46.40 |
| pH | 2.979 | 2.8 | 2.103 | 2.013 | 2.095 | 2.19 |
| Solid content (%) | 12.70 | 2.58 | 2.39 | 2.26 | 1.87 | 12.74 |
| Acidity (mg KOH/g) | 14.16 | 3.49 | 17.85 | 30.49 | 26.32 | 34.63 |
| Total weight (g) | 2000 | 700 | 700 | 600 | 500 | 2000 |

The results in table 1 show a decrease in formaldehyde concentration in relation to the total weight of the solutions obtained after each cycle. Moreover, the characteristics, as viscosity and solid content, have not changed compared to the starting solution.

In the starting solution 1, the amount of formaldehyde was 42 g (2.11% of the total weight), after the first cycle, the permeate solution 2 had 1.684% of formaldehyde, which is equivalent to 11.76 g of the total weight of the permeate solution 2 and the presence of the cationic melamine-formaldehyde resin was not detected in this solution. With the oxidation, the formaldehyde content is completely eliminated, therefore, after the mixing of the concentrate solution with the treated permeate solution, the total formaldehyde content in the system is reduced from 42 g to 30.24 g. Thus the cycles continue until the end of the process, separating the cationic melamine-formaldehyde resin of high molecular weight from the permeate solution, which is oxidized, avoiding its breakage.

### Example 1.2: Evaluation with Membrane Washing

The treated permeate was passed through the membrane for 15 minutes to remove any obstructions formed during each cycle, which reduce its permeability. This treated permeate from the membrane washing was added to the concentrate solution obtained in the same cycle to restore the original dispersion, as shown in FIG. 2. FIG. 2 is a schematic diagram of this process and its numbers represent the following descriptions:

9: Starting solution
10, 11 and 12: Permeate solution
14: Concentrate solution

### 15: Membrane

16: Conditions of the permeate solution treatment (H₂O₂ 35%, 50% excess at 75° C. during 2 h)

The results in table 2 show a decrease in formaldehyde concentration in relation to the total weight of the solutions obtained after each and the filtration time remained almost constant. As well as for the previous example, the characteristics, as viscosity and solid content, have not changed compared to the starting solution.

TABLE 2
Parameters analyzed in each cycle

| | Stream | | | | |
|---|---|---|---|---|---|
| | 9 | | | | 14 |
| | Starting | | | | Final |
| Parameters | Solution | 10 | 11 | 12 | Solution |
| Formaldehyde (%) | 2.11 | 1.56 | 1.06 | 0.67 | 0.67 |
| Hydrogen peroxide (%) | 0.00 | 0.00 | 0.00 | 0.04 | 0.00 |
| Viscosity (cP · s) | 40.60 | 2.40 | 0.60 | 0.55 | 47.80 |
| pH | 2.98 | 2.49 | 2.05 | 1.95 | 2.17 |
| Solid content (%) | 12.70 | 2.94 | 2.50 | 2.14 | 12.24 |
| Acidity (mg KOH/g) | 14.16 | 8.47 | 25.60 | 36.59 | 37.00 |
| Total weight (g) | 2000 | 707 | 707 | 656.5 | 2000 |

When compared with the Example 1.1 the washing steps in Example 1.2 is advantageous because the duration and the number of treatment cycles are reduced.

### Example 2: Application Test—Reverse Demulsifier

The evaluation of demulsification performance was verified by the TOG (Total Oil and Grease) Reduction test described below.

To implement the TOG Reduction test, an oily water sample was prepared in laboratory by adding slowly 50 drops of crude oil to 6 liters of deionized water, under high shear mixing (Ultra Turrax) at 2000 rpm, maintaining the mixing during 10 minutes, until the total dispersion of oil in water.

A solution 10% (v/v) of each proposed formulation (reverse demulsifier) below was prepared, using fresh water as solvent and the cationic melamine-formaldehyde resin, referred as polyelectrolyte in the table 3. Table 3 presents a description and free formaldehyde level of each proposed formulation.

TABLE 3
Description of each proposed formulation

| | Free | |
|---|---|---|
| | formaldehyde | |
| Identification | (%) | Description |
| Formulation #1 | 1.4 | Untreated polyelectrolyte - starting |
| | | material for formulations #2 and #3 |
| Formulation #2 | 0.2 | Treated polyelectrolyte, according to |
| | | the invention, adding water in the step |
| | | d) (6 cycles) |
| Formulation #3 | 0.2 | Treated polyelectrolyte, according to |
| | | the invention, adding the treated |
| | | permeate in the step d) (6 cycles) |

To each vessel containing 1 liter of oily water was added a volume of each formulation corresponding to the assessed concentration, as described in table 4. The solutions of each vessel were mixed. During the first minute, the rotation was maintained at 80 rpm, after the first minute, the rotation was decreased to 8 rpm and it was maintained during 10 minutes. Then, after this time, the mixing process was stopped and the solutions were allowed to stand for additional 30 minutes.

For the quantification of TOG by using ultraviolet-visible spectrophotometry analysis, 25 mL of water was collected from the bottom of each vessel with attention to the oil located at the surface. To each 25 mL of water it was added 25 mL of chloroform (CHCl₃), in order to extract all oil and grease from water. This mixture was transferred to a separation funnel and then, only the organic fraction was collected.

This fraction was evaluated in UV Vis Spectrophotometer at 400 nm, using the calibration curve data previously prepared to measure the TOG value.

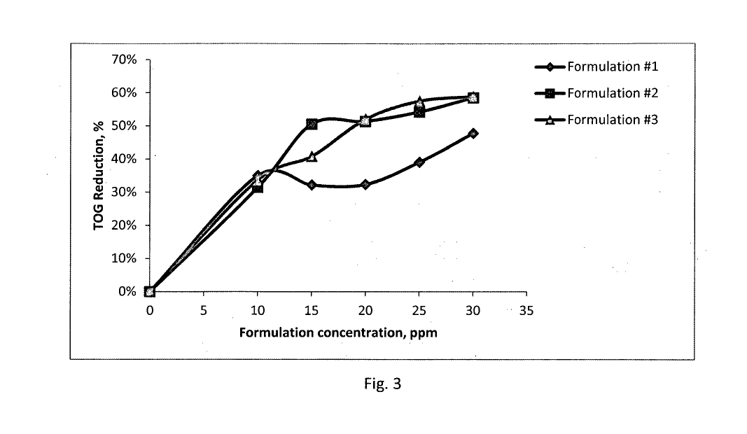

Considering that water quality may change significantly in the oilfield, it is suggested to compare the final results of the analysis starting from the same level of TOG and presenting the results as percentage of TOG reduction, as shown in the FIG. 3.

The results shown in FIG. 3 demonstrate that the three proposed formulations exhibit the same performance in reducing the TOG value, about 30%, when the concentration tested is up to 10 ppm. And for the cases tested with higher concentrations, the formulations #2 and #3 show a slightly better performance comparing with the formulation #1.

1. A process for reducing formaldehyde content from cationic melamine-formaldehyde resin solution, the process comprising the following steps:
a) Charging a starting solution of a cationic melamine-formaldehyde resin to an ultrafiltration membrane system;
b) Separating said starting solution into:
i. a concentrate solution which mainly comprises cationic melamine-formaldehyde resin of high molecular weight, formaldehyde and water, and
ii. a permeate solution which mainly comprises cationic melamine-formaldehyde resin molecules of low molecular weight, formaldehyde, acid compounds and water;
c) Treating the permeate solution to reduce the free formaldehyde content of the permeate;
d) Mixing the concentrate solution with treated permeate or with water.

2. The process according to claim 1, wherein the formaldehyde content of the starting solution is of between about 0.1% and 3.5%, by weight based on the weight of the starting solution.

3. The process according to claim 1, wherein the viscosity of the starting solution is between 10 cP·s and 100 cP·s.

4. The process according to claim 1, wherein the solid content of the starting solution is between 10% and 20%, by weight based on the weight of the starting solution.

5. The process according to claim 1, wherein the material of the ultrafiltration membrane system is selected from the group consisting of polysulphones, cellulose acetates, polyamides, vinyl chloride-acrylonitrile copolymers and poly(vinylidene fluoride).

6. The process according to claim 1, wherein the geometry of the ultrafiltration membrane system is selected from the group consisting of tubular, hollow fibre, spiral-wound, plate and frame.

7. The process according to claim 1, wherein the ultrafiltration membrane system has a pore size of between 5 kDa and 50 kDa.

8. The process according to claim 1, wherein the separation step (b) is operated at a pressure from 0.3 bar to 9.7 bar.

9. The process according to claim 8, wherein the pressure is applied with a pressure chamber with or without gas.

10. The process according to claim 1, wherein the staring starting solution is separated at a temperature from 15° C. to 30° C.

11. The process according to claim 1, wherein the concentrate solution comprises cationic melamine-formaldehyde resin of high molecular weight with a molecular weight higher than 50 kDa.

12. The process according to claim 1, wherein the permeate solution comprises cationic melamine-formaldehyde resin of low molecular weight with a molecular weight lower than 50 kDa.

13. The process according to claim 1, wherein the treatment step (c) comprises treating the permeate solution with a formaldehyde-free reducing agent selected from the group consisting of scavenging agent, precipitation agent and oxidizing agents.

14. The process according to claim 13, wherein the oxidizing agent is added in an amount of between 20% and 100% excess, by weight based on the weight of the permeate solution.

15. The process according to claim 1, wherein the permeate solution is treated during step (c) at a temperature from 15° C. to 100° C.

16. The process according to claim 1, wherein the permeate solution is cooled after step (c) at a temperature from 15° C. to 50° C.

17. The process according to claim 1, wherein the mixing step (d) is performed with water or with the treated permeate.

18. The process according to claim 1, wherein the concentrate solution is charged as part of the starting solution to another ultrafiltration membrane system and the process is repeated as many times as necessary to reach formaldehyde content less than 0.1%.

19. The process according to claim 1, wherein the ultrafiltration membrane systems regenerated by washing with water or with the treated permeate.

20. A cationic melamine-formaldehyde resin obtained from the process as defined in claim 1.

21.-24. (canceled)
